(19) United States
(12) Patent Application Publication
(10) Pub. No.: US 2013/0198056 A1
(43) Pub. Date: Aug. 1, 2013

(54) NEAR FIELD COMMUNICATION TRANSACTION MANAGEMENT AND APPLICATION SYSTEMS AND METHODS

(71) Applicants: Raul I. Aldrey, Plano, TX (US); Anthony M. Lemus, Irving, TX (US); Donald H. Relyea, Dallas, TX (US); Brian F. Roberts, Dallas, TX (US)

(72) Inventors: Raul I. Aldrey, Plano, TX (US); Anthony M. Lemus, Irving, TX (US); Donald H. Relyea, Dallas, TX (US); Brian F. Roberts, Dallas, TX (US)

(73) Assignee: VERIZON PATENT AND LICENSING INC., Basking Ridge, NJ (US)

(21) Appl. No.: 13/359,992

(22) Filed: Jan. 27, 2012

(51) Int. Cl. G06Q 40/02; H04B 7/00

(52) U.S. Cl. 705/38; 455/41.2

(57) ABSTRACT

Exemplary near field communication (“NFC”) transaction management and application systems and methods are disclosed herein. An exemplary method includes a computing system tracking NFC transactions associated with a profile and providing a service based on the tracked NFC transactions associated with the profile. In certain examples, the tracking includes aggregating the NFC transactions associated with the profile over time. In certain examples, the profile comprises a customer premises profile specifying one or more customer premises equipment (“CPE”) devices for which to track the NFC transactions. Corresponding methods and systems are also disclosed.

### BACKGROUND INFORMATION

Near field communication (“NFC”) technology is a communications technology that allows two devices that are in close physical proximity to one another (e.g., within physical contact or within a few inches of each other) to establish a wireless communication connection and to exchange communications and/or data over the wireless communication connection. Certain mobile user devices, such as mobile smartphone devices, implement and are able to use NFC technology to communicate with other NFC-enabled devices to which the mobile user devices come in close physical proximity. Due at least in part to security provided by the short range of NFC communications, NFC technology is expected to become a widely used method of payment. For example, a user of an NFC-enabled smartphone device may position the smartphone device proximate to an NFC-enabled receiver device at a store checkout such that the smartphone device transmits payment information (e.g., credit card information) to the NFC-enabled receiver device to render payment. However, up to now, uses and/or applications of NFC technology have been limited.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary computing system according to principles described herein.

FIG. 2 illustrates an exemplary customer premises profile according to principles described herein.

FIG. 3-8 illustrate exemplary implementations of the system of FIG. 1 according to principles described herein.

FIG. 9 illustrates an exemplary near field communication (“NFC”) transaction management and application method according to principles described herein.

FIG. 10 illustrates an exemplary computing device according to principles described herein.

### DETAILED DESCRIPTION OF PREFERRED EMBODIMENTS

Near field communication (“NFC”) transaction management and application systems and methods are disclosed herein. In certain exemplary embodiments, NFC transactions may be managed by a computing system, such as by the computing system tracking NFC transactions over time. The NFC transactions may be applied by the computing system, such as by the computing system providing one or more services based on the tracked NFC transactions. Examples of tracking and using tracked NFC transactions to provide one or more services are described in detail herein.

An “NFC transaction,” as used here, may refer to any short-range wireless communication or set of short-range wireless communications between devices that are configured to communicate in accordance with NFC technologies defined by one or more standards-defining entities (e.g., ISO/IEC, ECMA, NFC Forum, etc.). For example, two appropriately configured devices may communicate short-range using NFC protocols and/or data exchange formats defined by one or more NFC standards. Additionally or alternatively, an “NFC transaction” may refer to any short-range wireless communication between devices configured to communicate using any other suitable short-range wireless communications technologies. Devices configured to communicate one with another by way of an NFC transaction may be referred to as “NFC-enabled devices.” Examples of NFC-enabled devices and NFC transactions are described herein.

By managing and applying NFC transactions as described herein, the exemplary systems and methods described herein may provide new and/or improved services and/or features. The services and/or service features may make the performance of one or more user activities more efficient, convenient, and/or reliable than before. For example, the services and/or service features may make certain activities related to maintaining a structural premises (e.g., a customer premises such as a home and/or workplace) more efficient, convenient, and/or reliable for a user. These and additional or alternative benefits and/or advantages that may be provided by the exemplary systems and methods will be made apparent herein.

Exemplary NFC transaction management and application systems and methods will now be described in reference to the drawings.

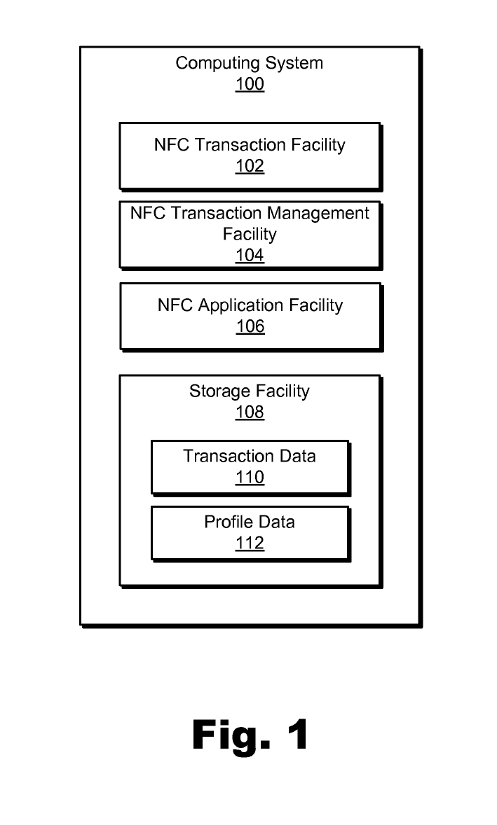

FIG. 1 illustrates an exemplary computing system 100 (“system 100”) configured to manage and apply NFC transactions. As shown, system 100 may include, without limitation, an NFC transaction facility 102 (“transaction facility 102”), an NFC transaction management facility 104 (“management facility 104”), an NFC application facility 106 (“application facility 106”), and a storage facility 108 selectively and communicatively coupled to one another. It will be recognized that although facilities 102-108 are shown to be separate facilities in FIG. 1, any of facilities 102-108 may be combined into fewer facilities, such as into a single facility, or divided into more facilities as may serve a particular implementation.

Storage facility 108 may be configured to store data generated and/or used by one or more facilities 102-106. For example, storage facility 108 may store transaction data 110 representative of one or more NFC transactions participated in by transaction facility 102 and/or managed by management facility 104. Storage facility 108 may also store profile data 112 representative one or more user, device, and/or group profiles to which NFC transactions may be associated. Examples of profiles and associations of NFC transactions with profiles are described herein. Storage facility 108 may store additional or alternative data as may suit a particular implementation of system 100.

Transaction facility 102 may be configured to participate in NFC transactions. For example, transaction facility 102 may be implemented by one or more devices such that the devices are NFC-enabled and therefore capable of transmitting and/or receiving NFC communications to participate in an NFC transaction. Transaction facility 102 may employ any suitable NFC technologies to support NFC transactions between NFC-enabled devices that implement transaction facility 102.

Management facility 104 may be configured to manage NFC transactions between NFC-enabled devices. For example, management facility 104 may be configured to track NFC transactions, such as by tracking, over time, NFC transactions in which NFC-enabled devices participate. The tracking may include aggregating and storing data representative of and/or associated with NFC transactions.

Management facility 104 may be configured to track NFC transactions that are associated with a particular user, user profile, NFC-enabled device, device profile, group of users, group of devices (e.g., a set of customer premises equipment devices located at a customer premises), and/or customer premises profile (e.g., a home or business location profile). For example, management facility 104 may aggregate, over time, data representative of NFC transactions that are specific to a particular user, user profile, NFC-enabled device, device profile, group of users, group of devices, and/or customer premises profile.

Management facility 104 may be configured to provide a user interface through which a user may configure and/or otherwise manage the tracking of NFC transactions. For example, through the user interface, a user may define settings to be used by management facility 104 to govern tracking of NFC transactions. For instance, a user may input information to identify specific NFC-enabled devices, users, profiles, etc. for which NFC transactions are to be tracked. To illustrate one example, a user may use the user interface to define a profile and settings configured to direct management facility 104 to track NFC transactions related to the profile. For instance, the user may define a customer premises profile, such as by identifying one or more devices and/or users associated with the customer premises. Based on this definition, management facility 104 may track NFC transactions that involve the identified devices and/or users specified by the customer premises profile.

As an example, the user may input a serial number for each NFC-enabled device for which NFC transactions are to be tracked. Management facility 104 may then use the serial numbers to obtain NFC transaction data (e.g., NFC transaction history data) from specific NFC-enabled devices having those serial numbers. To this end, in certain embodiments, as part of an NFC transaction between two NFC-enabled devices, management facility 104 implemented by one of the devices may request that the other device provide the serial number of the other device. The other device may provide the serial number, and the requesting device may compare the serial number against a list of device serial numbers specified by a customer premises profile. If a match is found, the device may request that the other device provide an NFC transaction history of the other device. The other device may provide data representative of its NFC transaction history by way of the NFC transaction, and the receiving device may store and maintain the data.

As another example, a user may input GPS coordinates associated with a customer premises (or other information indicating a geographic location of the customer premises). Thereafter, management facility 104 may use the GPS coordinates to determine whether to obtain NFC transaction history data from a device in conjunction with an NFC transaction with the device. For example, management facility 104 may request and receive NFC transaction history data from an NFC-enabled device physically located at the GPS coordinates (i.e., at the customer premises) in response to a determination that the device implementing the management facility 104 and/or the NFC-enabled device is located at the GPS coordinates during the NFC transaction.

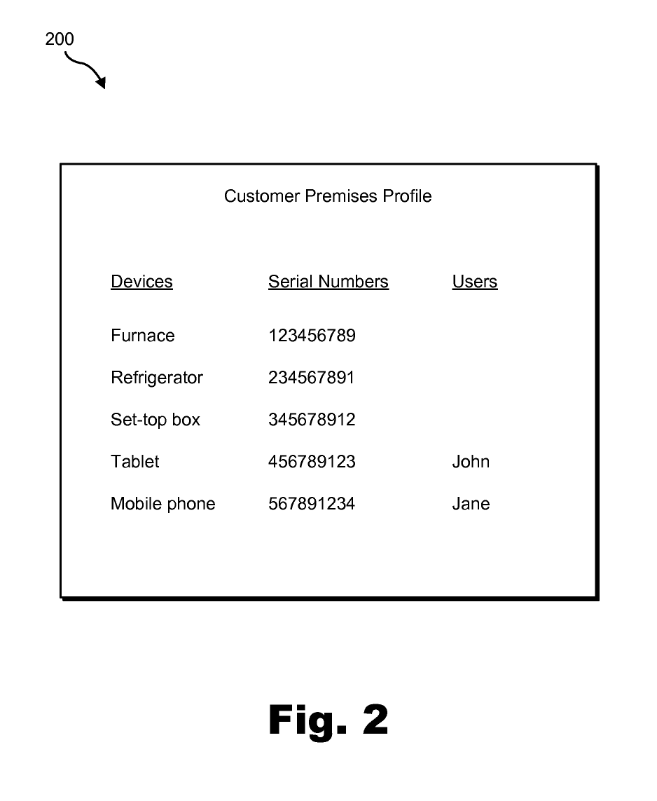

FIG. 2 illustrates an exemplary customer premises profile 200 that specifies a set of NFC-enabled devices associated with a customer premises and for which NFC transactions are to be tracked. As shown, the devices may include a furnace, a refrigerator, a set-top box device, a tablet computer, and a mobile phone device. Profile 200 specifies labels and serial numbers for these devices. Profile 200 may further specify users associated with specific devices. For example, profile 200 specifies that a user named “John” is associated with the tablet computer and that a user named “Jane” is associated with the mobile phone device. With profile 200 defined as shown in FIG. 2, computing system 100 is prepared to track NFC transactions associated with profile 200, which includes tracking NFC transactions involving the devices and/or users specified in profile 200. Profile 200 is illustrative of one example of a profile that may be defined and specify devices and/or users for which to track NFC transactions. Other profiles may be defined in other examples.

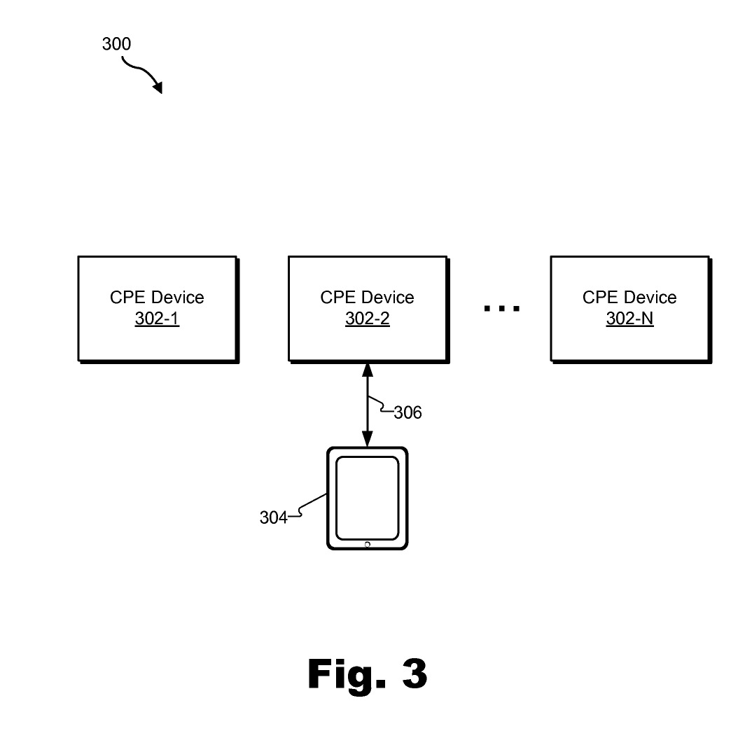

Management facility 104 may be configured to track NFC transactions in any suitable way and at any suitable location. To illustrate, examples of tracking NFC transactions will now be described in reference to exemplary implementations of system 100 shown in FIGS. 3-7.

FIG. 3 shows an exemplary implementation 300 of system 100 in which one or more customer premises equipment (“CPE”) devices 302 (e.g., CPE devices 302-1 through 302-N) implement one or more facilities 102-108 of system 100. The one or more facilities 102-108 may be implemented by one or more CPE devices 302 in a standalone manner or in a distributed manner. Each CPE device 302 may be an NFC-enabled device capable of sending and/or receiving NFC communications to/from another NFC-enabled device that is physically located within short range of the CPE device 302. In certain embodiments, a CPE device 302 may include any device that is physically located at a customer premises or that may be physically located at a customer premises such as a home or workplace. Examples of CPE devices 302 include, without limitation, appliances (e.g., a refrigerator, freezer, oven, stove, microwave, furnace, air conditioning unit, water softener, water filter, etc.), utilities monitoring devices (e.g., a gas or power consumption monitoring device), personal computers, consumer electronics devices (e.g., a set-top box device, digital video recorder device, gaming console, media server, router, modem, etc.), and any other devices that are or may be located at a customer premises and may implement one or more facilities 102-108 of system 100. In certain examples, a CPE device 302 may include an active NFC-enabled device or a passive NFC-enabled device (e.g., an NFC tag).

Implementation 300 may further include a mobile user device 304, which may be an NFC-enabled device and may implement one or more facilities 102-108 of system 100 in a standalone or distributed manner. Mobile user device 304 may include any portable device that is or may be physically located at the customer premises. Examples of mobile user device 304 include, without limitation, mobile phone devices, smartphones, tablet computers, handheld remote control devices, handheld media players, and any other portable devices that are of may be located at the customer premises and may implement one or more facilities 102-108 of system 100.

When mobile user device 304 is physically within short range of a CPE device 302, the mobile user device 304 and the CPE device 302 may exchange one or more NFC communications to participate in an NFC transaction between the devices. As an example, line 306 in FIG. 3 represents an NFC transaction between mobile user device 304 and CPE device 302-2. A user of mobile user device 304 may initiate an NFC transaction between the mobile user device 304 and another NFC-enabled device (e.g., any of CPE devices 302) by positioning the mobile user device 304 within short range distance of the other device. For example, the user may “bump” mobile user device 304 to another device. When the devices are “bumped” together, the devices are within short range distance of one another (i.e., physically touching and/or in close physical proximity) and may exchange one or more NFC communications to participate in an NFC transaction between the devices.

Any of the devices shown in FIG. 3 may implement management facility 104 and be configured to track NFC transactions over time. As an example, CPE device 302-1 may be configured to track NFC transactions in which CPE device 302-1 participates. To illustrate, CPE device 302-1 may be an NFC-enabled refrigerator. A manufacturer of the refrigerator may store data representative of attributes of the refrigerator (e.g., serial number, specifications, warranty information, etc.) within the refrigerator such that the data may be shared by the refrigerator with another NFC-enabled device by way of an NFC transaction between the devices. When a customer first purchases the refrigerator, a salesman may use an NFC-enabled device to transmit, through an NFC transaction with the refrigerator, information about the purchase to the refrigerator. The refrigerator may receive and store data representative of the information about the purchase (e.g., information about the date of purchase, a location and/or retailer associated with the purchase, a purchase amount, etc.). Similarly, when the refrigerator is delivered to a customer premises (e.g., the customer's home or workplace), installed at the customer premises, and/or serviced by a service technician, a person associated with the delivery, installation, and/or service visit may use an NFC-enabled device to transmit data representative of information about the delivery, installation, and/or service visit to the refrigerator. The refrigerator may receive and aggregate data representative of the information about the delivery, installation, and/or service visit with other data associated with other NFC transactions in which the refrigerator has participated. In this or a similar manner, the refrigerator may track, over time, NFC transactions in which the refrigerator participates and aggregate and store data representative of the NFC transactions and/or information associated with the NFC transactions. In this manner, the refrigerator may maintain an NFC transaction history for the refrigerator. Any other appropriately configured CPE device 302 may be configured to track NFC transactions associated with the CPE device 302 in a similar manner.

As another example, mobile user device 304 may implement management facility 104 such that mobile user device 304 is configured to track NFC transactions in which mobile user device 304 participates. To illustrate, mobile user device 304 may be an NFC-enabled smartphone device associated with (e.g., operated by) a user, and CPE devices 302 may be physically located at a customer premises associated with the user. The user may utilize mobile user device 304 to initiate NFC transactions between the mobile user device 304 and each of the CPE devices 302 (e.g., by physically bumping the mobile user device 304 to each of the CPE devices 302 to automatically initiate the NFC transactions). Mobile user device 304 may track over time, NFC transactions in which the mobile user device 304 participates and aggregate and store data representative of the NFC transactions and/or information associated with the NFC transactions. In this manner, mobile user device 304 may maintain an NFC transaction history for the mobile user device 304.

In certain implementations, mobile user device 304 may be configured to request and receive NFC transaction histories from CPE devices 302 by way of NFC transactions between the mobile user device 304 and the CPE devices 302. For example, a user of mobile user device 304 may bump the mobile user device 304 against CPE device 302-1. In response, mobile user device 304 and CPE device 302-1 may exchange NFC communications to participate in an NFC transaction. The NFC communications may include mobile user device 304 requesting an NFC transaction history and associated information (e.g., which may include information about attributes of CPE device 302-1) from CPE device 302-1. In response, CPE device 302-1 may transmit and mobile user device 304 may receive, by way of the NFC transaction, data representative of the NFC transaction history of CPE device 302-1. To illustrate, in an example in which CPE device 302-1 is an NFC-enabled refrigerator, mobile user device 304 may request and receive, from the refrigerator by way of an NFC transaction with the refrigerator, the NFC transaction history of the refrigerator. As part of this NFC transaction, mobile user device 304 may receive any information associated with CPE device 302-1 and/or the NFC transaction history of CPE device 302-1. For example, mobile user device 304 may receive data representative of the serial number, specifications, and/or operating status of CPE device 302-1. In this manner, mobile user device 304 may aggregate and maintain data representative of NFC transaction histories and associated information for one or more other NFC-enabled devices such as CPE devices 302.

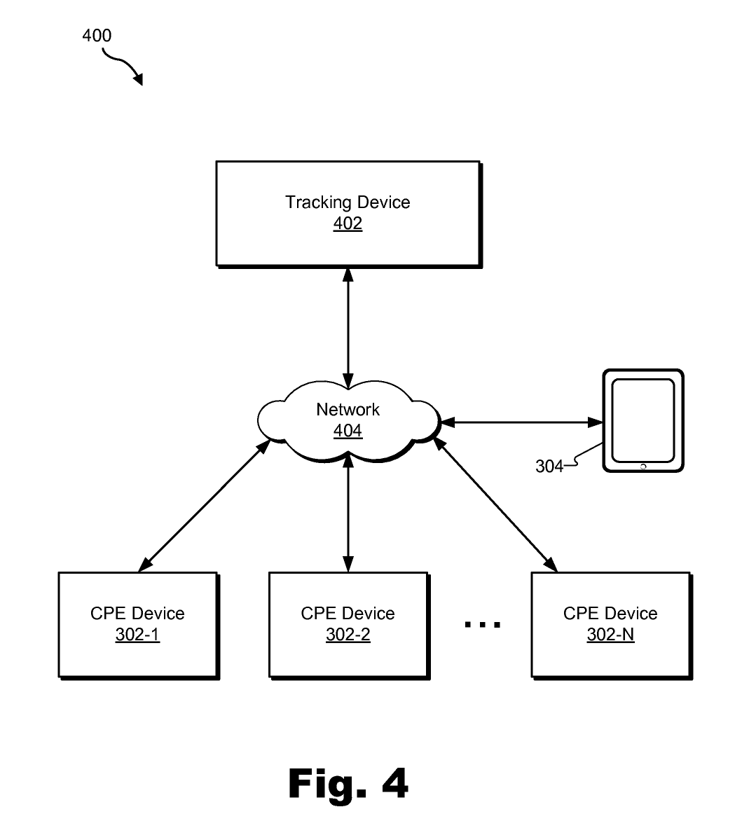

As another example, in certain implementations, a device other than mobile user device 304 may implement management facility 104 such that the device is configured to obtain and aggregate NFC transaction histories for one or more other devices. To illustrate, FIG. 4 shows an exemplary implementation 400 of system 100 in which a tracking device 402 implements management facility 104 and is configured to obtain and aggregate NFC transaction histories for CPE devices 302 and/or mobile user device 304. Tracking device 402 may be configured to request and receive NFC transaction history data from one or more CPE devices 302 and/or mobile user device 304 by way of any suitable direct or indirect communication paths. For example, in FIG. 4, tracking device 402 is configured to communicate with CPE devices 302 and mobile user device 304 by way of a network 404. Accordingly, tracking device 402 may request and receive NFC transaction history data from CPE devices 302 and/or mobile user device 304 by way of network 404.

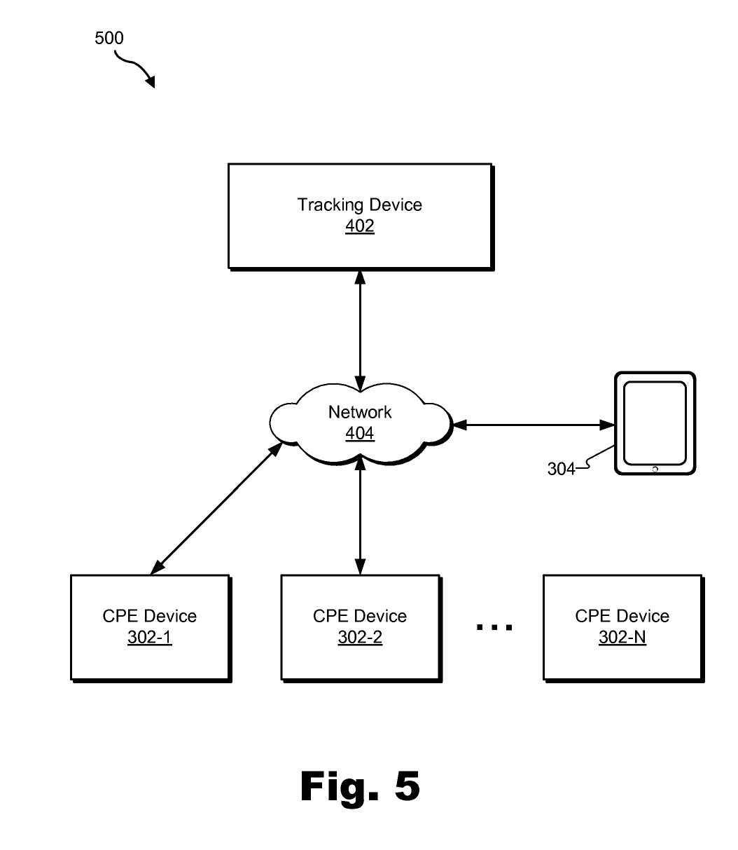

In other examples, one or more CPE devices 302 and/or mobile user device 304 may not be configured to communicate with tracking device 402 by way of network 404. Tracking device 402 may obtain NFC transaction history data for those devices by way of other communication paths. For example, FIG. 5 illustrates an exemplary implementation 500 of system 100 in which CPE device 302-N is not configured to communicate by way of network 404. Mobile user device 304 may obtain NFC transaction history data from CPE device 302-N by way of an NFC transaction with CPE device 302-N. Mobile user device 304 may then provide the NFC transaction history data for CPE device 302-N to tracking device 402 by way of network 404 and/or by way of an NFC transaction between mobile user device 304 and tracking device 402.

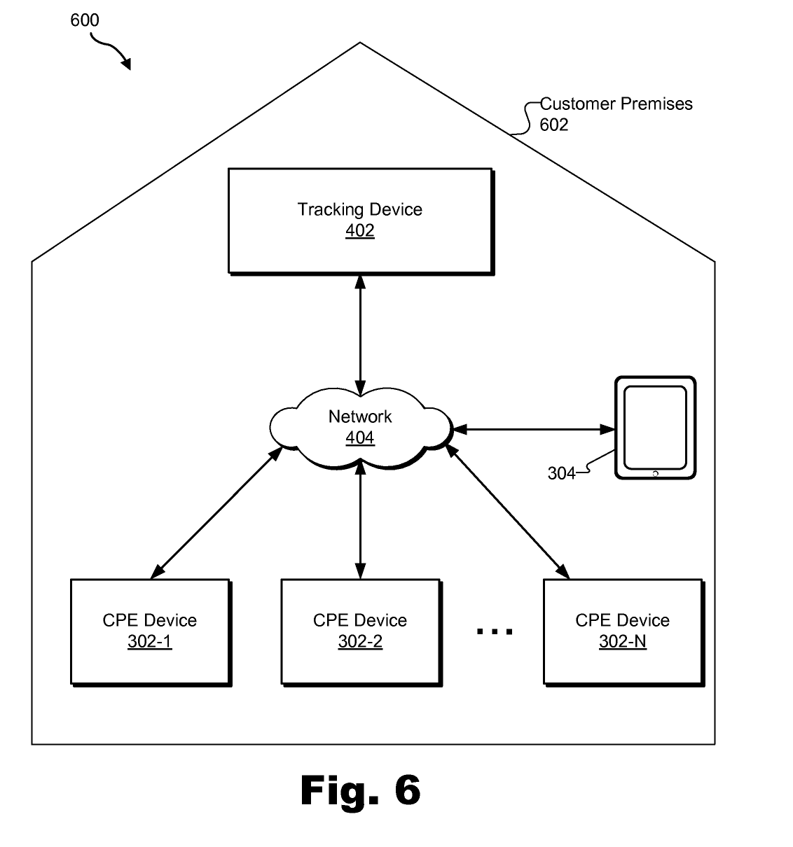

In certain implementations, tracking device 402 may be located at a customer premises (e.g., together with CPE devices 302). In such embodiments, network 404 may comprise a local area network (e.g., a Wi-Fi network) at the customer premises, and tracking device 402 may include any CPE device located at the customer premises (e.g., a gateway device, a media server device, etc.). FIG. 6 illustrates an implementation 600 in which tracking device 402 is located at a customer premises 602 at which network 404 is provided and at which CPE devices 302 and mobile user device 304 are also located. While FIG. 6 illustrates each of CPE devices 302 and mobile user device 304 as having connections with network 404, this is illustrative only. One or more of CPE devices 302 and/or mobile user device 304 may not be connected to network 404 in other embodiments.

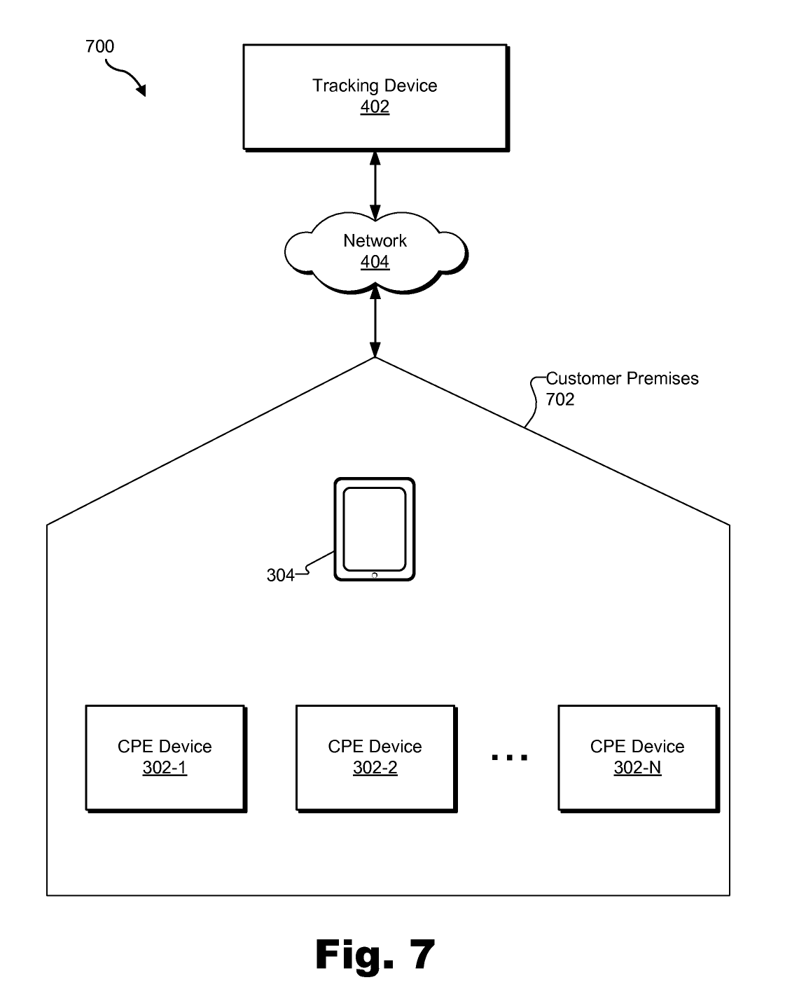

In other implementations, tracking device 402 may be located remote of the customer premises. For example, tracking device 402 may include one or more remote server devices operated by a service provider. In such embodiments, network 404 may include a wide area network such as the Internet, a mobile data communications network, and/or any other wide area network. FIG. 7 illustrates an implementation 700 in which tracking device 402 is located remote of a customer premises 702 at which CPE devices 302 and mobile user device 304 are located. Any of CPE devices 302 and mobile user device 304 may be configured to communicate with tracking device 402 by way of network 404.

In certain embodiments, tracking device 402 may be configured to operate as a conduit for one or more of the operations described herein. For example, in the embodiment shown in FIG. 6, a user of mobile user device 304 may bump the mobile user device 304 to tracking device 402 to obtain NFC transaction histories of CPE devices 302 instead of bumping mobile user device 304 to each of the CPE devices 302 individually. As another example, in the embodiment shown in FIG. 7, mobile user device 304 may download NFC transaction histories of CPE devices 302 from tracking device 402 from any location at which mobile user device 304 is able to access network 404. Tracking device 402 may similarly operate as a conduit for one or more of the services provided by application facility 106 based on tracked NFC transactions.

Returning to FIG. 1, application facility 106 may be configured to apply NFC transactions, such as by providing one or more services based on one or more NFC transactions (e.g., NFC transactions that have been tracked by management facility 104 as described above). Application facility 106 may be implemented in a standalone or distributed manner by one or more computing devices, including by any of CPE devices 302, mobile user device 304, tracking device 402, and/or other NFC-enabled devices. Examples of services that may be provided by application facility 106 based on one or more NFC transactions will now be described.

In certain embodiments, application facility 106 may provide an NFC transaction based service by automatically enabling and/or disabling access to a feature based on one or more NFC transactions. To illustrate, a CPE device 302 located at a customer premises may be configured to provide a feature. For example, the CPE device 302 may include a media content processing device configured to provide access to certain media content (e.g., certain television, pay-per-view, and/or on-demand content), media content channels, and/or media services.

Application facility 106 may be configured to automatically enable or disable access to the feature based on one or more NFC transactions. For instance, application facility 106 may be configured to enable access to the feature when tracked NFC transactions indicate that a mobile user device (e.g., mobile user device 304) associated with a user is physically located at the customer premises and to disable access to the feature when the tracked NFC transactions indicate that the mobile user device is not physically located at the customer premises.

The tracked NFC transactions may indicate the position of the mobile user device associated with the user in any suitable way. For example, the tracked NFC transactions may indicate information about the location of the mobile user device when the mobile user device last participated in an NFC transaction. From this information, application facility 106 may determine that the mobile user device recently (e.g., within a predetermined length of time) participated in an NFC transaction at the customer premises (e.g., with a CPE device 302 located at the customer premises) that would indicate that the mobile user device is located (or is likely located) at the customer premises. Alternatively, from the information, application facility 106 may determine that the mobile user device recently participated in an NFC transaction away from the customer premises or has not recently participated in an NFC transaction within the customer premises, which would indicate that the mobile user device is not (or is likely not) located at the customer premises. If application facility 106 is unable to determine the current location of the mobile user device relative to the customer premises with an acceptable predefined level of confidence, application facility 106 may automatically disable the feature and prompt the user to initiate an NFC transaction between the mobile user device and an NFC-enabled device at the customer premises to indicate that the mobile user device is located at the customer premises.

In some examples, application facility 106 may be configured to automatically enable or disable access to the feature based on a specific location of a mobile user device within a customer premises, the location being indicated by one or more NFC transactions in which the mobile user device participates. For example, application facility 106 may enable a feature provided by a CPE device 302 when the mobile user device is located within the same room as the CPE device 302 and disable the feature when the mobile user device is not located within the same room as the CPE device 302. In some examples, application facility 106 may prompt the user to initiate an NFC transaction between the mobile user device and the CPE device 302 configured to provide the feature in order to verify that the mobile user device is in the same room as the CPE device 302.

As an example, a user of a CPE device 302 located at the user's home may want certain media content that is accessible through the CPE device 302 to be available only when the user is at home and to not be available when the user is not at home. For instance, the user may not want the user's children and/or the children's babysitter to be able to access certain media content while the user is away from the home. Accordingly, the user may configure application facility 106 to automatically enable access to the media content when the user's smartphone device is located at the home and to automatically disable access to the media content when the user's smartphone device is located away from the home.

As another example, selectively enabling and disabling access to a feature based on NFC transactions may include application facility 106 automatically logging a user in or out of a service and/or service feature. For instance, application facility 106 may detect, based on tracked NFC transactions, that a mobile user device associated with a user is located at the user's home. In response, application facility 106 may automatically log the user in to a service and/or service feature provided by a CPE device 302 located at the home. On the other hand, application facility 106 may detect, based on tracked NFC transactions, that a mobile user device associated with a user is located away from the user's home. In response, application facility 106 may automatically log the user out of a service and/or service feature provided by a CPE device 302 located at the home.

In certain embodiments, application facility 106 may provide an NFC transaction based service by dynamically modifying display content based on one or more NFC transactions. For example, a CPE device 302 may maintain a digital family calendar and display graphical data representing the family calendar on a display screen. CPE device 302 may be configured to automatically modify the family calendar content based on one or more tracked NFC transactions.

As an example, the CPE device 302 may selectively display or not display a calendar entry associated with a family member depending on whether a mobile user device associated with family member is located at the family's home. For instance, when the family member's mobile user device is located at the home (as indicated by one or more NFC transactions between the family member's mobile user device and the CPE device 302), one or more calendar entries associated with the family member may be displayed and/or made more prominent on the digital family calendar. When the family member's mobile user device is not located at the home (as indicated by a lack of one or more NFC transactions between the family member's mobile user device and the CPE device 302), one or more calendar entries associated with the family member may be hidden or made less prominent on the digital family calendar. Alternatively, a calendar entry associated with a family member may be automatically hidden when the family member's mobile user device is located at the home (e.g., an entry about a surprise party for Grandma may be automatically hidden from display on the digital family calendar when a mobile user device associated with Grandma is located in the home).

As another example, application facility 106 may determine a calendar event based on tracked NFC transactions and automatically add data representative of the calendar event to a digital family calendar. For example, application facility 106 may determine, from tracked NFC transactions associated with a CPE device 302, a recommended maintenance date for the CPE device 302. For instance, from an NFC transaction history of the CPE device 302, application facility 106 may determine a recommended maintenance date for the CPE device 302 (e.g., a date of a recommended maintenance event for a home appliance such as a furnace, refrigerator, water softener, etc.) and automatically add a calendar entry representing the recommended maintenance event to the digital family calendar. A user viewing a display of the digital family calendar may be reminded of the recommended maintenance event and may perform or schedule the recommended maintenance.

In certain embodiments, application facility 106 may provide an NFC transaction based service by dynamically modifying one or more operational settings of a CPE device based on one or more NFC transactions. For example, a CPE device 302 may be configured to select a set of settings from multiple sets of settings and to operate in accordance with the selected set of settings. In some examples, each set of settings may correspond to a particular user of the CPE device 302. When a user wants the CPE device 302 to operate in accordance with settings associated with the user, the user may bump the user's mobile user device to the CPE device 302 to initiate an NFC transaction. The CPE device 302 may respond to the NFC transaction by selecting the set of settings that correspond to the user and operating in accordance with the selected set of settings.

To illustrate, the CPE device 302 may be a set-top box device. When a user wants to watch television through the set-top box device, the user may bump the user's smartphone device to the set-top box device to initiate an NFC transaction. Based on this NFC transaction, the CPE device 302 may modify one or more operational settings such that the CPE device 302 is configured to operate in accordance with a set of settings associated with the user.

To illustrate another example, an NFC-enabled desktop computer and/or telephone device in a shared office may be configured to automatically select different user settings for operation based on which user is in the office. For example, a user who wishes to use the office may bump the user's mobile user device to the desktop computer and/or the telephone device to initiate an NFC transaction with each device. Each device may respond by selecting settings associated with the user of the mobile user device and operating in accordance with the selected settings.

As another example, application facility 106 may modify operational settings of a CPE device 302 to dynamically modify operation of the CPE device 302 and/or other devices at a customer premises based on tracked NFC transactions. To illustrate, application facility 106 may be configured to pinpoint a location of a user within a home based on NFC transactions and to modify settings of one or more devices in the home such as by moving audio broadcasting from room to room based on movement of the user within the home and/or by turning lights on and/or off based on the location of the user within the home.

In certain embodiments, application facility 106 may provide an NFC transaction based service by providing information about a physical feature of a customer premises. The information may be stored in an NFC-enabled device such as a passive NFC tag located at the customer premises. To illustrate, a contractor may install tile work in a home. The contractor may add data representative of information about the tile work to an NFC tag and embed the NFC tag in the tile work. The information may include any information about or related to the tile work, information about the contractor (e.g., the contractor name, phone number, email address, business card, etc.) who installed the tile work in the home, information about the tile (e.g., a name of the tile, a name of a store at which the tile was purchased, etc.), information about the installation of the tile (e.g., a date of the installation), information about maintenance activities performed on the tile (e.g., a date that the tile was cleaned, sealed, resealed, grouted, or re-grouted), and links to any information and/or additional information related to the tile work.

Accordingly, a user who wants to access information about the tile work may bump an NFC-enabled mobile user device to the NFC tag to initiate an NFC transaction in which data representative of the information stored by the NFC tag may be transmitted to the mobile user device. The user may then access and use the information received by the mobile user device as may suit the user, such as to contact a contractor who worked on the tile work, to determine where to purchase the tile, and/or to determine when and/or how to maintain the tile work.

In certain embodiments, application facility 106 may provide an NFC transaction based service by providing information about a CPE device 302 located at the customer premises. The information may include historical information associated with an NFC transaction history of the CPE device 302.

As an example, a CPE device 302 may be an NFC-enabled refrigerator at a home. The refrigerator may track NFC transactions associated with the refrigerator as described above and store data representative of the NFC transaction history of the refrigerator, which may include any information about the attributes of the refrigerator. A user who wants to access information about the refrigerator may bump an NFC-enabled mobile user device to the refrigerator to initiate an NFC transaction in which data representative of the NFC transaction history and related information stored by the refrigerator may be transmitted to the mobile user device. The user may then access and use the information received by the mobile user device as may suit the user, such as to determine the physical dimensions of the refrigerator, where the refrigerator was purchased, when the refrigerator was last serviced, who serviced the refrigerator, the next recommended service for the refrigerator, and/or any other information about the refrigerator. For instance, the user may be interested in purchasing a new refrigerator having the same physical dimensions or in purchasing a replacement water filter for the refrigerator. The user may bump the user's mobile user device to the refrigerator to obtain information about the refrigerator such that the user may conveniently bring the information about the refrigerator stored on the mobile user device with the user to shop for a new refrigerator and/or replacement water filter.

In certain examples, the information about the CPE device 302 may include historical information included in an NFC transaction history of the CPE device 302. To illustrate, the CPE device 302 may be an NFC-enabled refrigerator configured to track NFC transactions involving the refrigerator over time and to store an NFC transaction history including information associated with the tracked NFC transactions. The NFC transaction history may include information about at least one of a purchase, a delivery, an installation, maintenance, and any other event and/or usage associated with the refrigerator.

Such historical information about the CPE device 302 may be applied in a number of ways. As an example, the CPE device 302 may be an NFC-enabled refrigerator, and an owner of the refrigerator may want to sell the refrigerator such as by using an online classified advertisement service. The owner may obtain historical information about the refrigerator from the refrigerator as described above and post the historical information to a classified advertisement for the refrigerator to help promote the refrigerator to one or more prospective buyers.

As another example, the NFC transaction history of the refrigerator may be published to an online service. This may include tracking device 402 located remote of a customer premises as shown in FIG. 7 obtaining and storing data representative of the NFC transaction history of the refrigerator. The tracking device 402 may then distribute the NFC transaction history as part of a service. To illustrate, an owner of the refrigerator may want to sell the refrigerator and may post an online classified advertisement for the refrigerator. The owner may include the serial number of the refrigerator in the advertisement. A prospective buyer may view the add, note the serial number, and submit the serial number to a third-party service to request the NFC transaction history of the device having that serial number. For example, a user may submit the serial number to tracking device 402, which may use the serial number to identify the NFC transaction history for the refrigerator. Tracking device 402 may then provide data representative of the NFC transaction history of the refrigerator to the user, and the user may inspect the NFC transaction history to help determine a level of interest in purchasing the refrigerator.

In certain embodiments, application facility 106 may provide an NFC transaction based service by providing maintenance notifications based on tracked NFC transactions. For example, based on tracked NFC transactions, application facility 106 may provide a maintenance notification configured to notify a user of a recommended maintenance activity for a CPE device 302 located at a customer premises. The recommended maintenance activity may include any activity that may be performed to maintain, repair, service, update, and/or adjust settings of the CPE device.

To illustrate, the CPE device 302 may be a refrigerator that maintains an NFC transaction history as described above. Application facility 106 may be configured to analyze the NFC transaction history against a recommended maintenance heuristic (which may be provided by a refrigerator manufacturer and/or service technician) to determine a recommended maintenance activity and/or date. For instance, application facility 106 may determine, from the NFC transaction history, a date that a water filter was installed in the refrigerator. Application facility 106 may also determine, from the recommended maintenance heuristic, a recommended lifetime of the water filter (e.g., based on an amount of water filtered and/or a length of time in use). Based on this information, application facility 106 may determine a recommended date on which a replacement water filter should be ordered and/or installed. Application facility 106 may then provide notification of this date and/or maintenance activity.

The notification may be provided in any suitable way. For example, a mobile user device that has obtained the NFC transaction history of the refrigerator as described above may display the notification for viewing by a user of the mobile user device. As another example, application facility 106 may provide the notification by adding a new calendar entry to replace the water filter in the refrigerator to a digital family calendar displayed by a CPE device 302 in a home, as described above.

As another example, application facility 106 may provide a maintenance notification configured to notify a user of a recommended maintenance activity that the user may perform to enhance the efficiency of a CPE device 302. For instance, from tracked NFC transactions, application facility 106 may detect one or more patterns, such as times of a day that a user is typically located at and/or away from home. Application facility 106 may compare this information against an operational history of a CPE device 302 such as a furnace in the home, which may be obtained by way of an NFC transaction with the furnace as described above. Based on the comparison and on an optimal heating heuristic (which may be provided by a utility service provider such as a natural gas provider and/or furnace service technician), application facility 106 may provide a notification including one or more recommendations for adjusting the operation of the furnace to be more efficient (e.g., by keeping the home cooler during times of the day that the user is historically away from the home).

In certain embodiments, application facility 106 may provide an NFC transaction based service by providing an NFC transaction based user credit rating. For example, from tracked NFC transactions associated with a user, and particularly from tracked NFC transactions that involve the user rendering or accepting monetary payments, application facility 106 may determine an NFC transaction rating for the user. The rating may be determined based on any predefined criteria, which may include a quantity of NFC transactions, a ratio of successful NFC transactions (e.g., successful payments) to unsuccessful NFC transactions (e.g., unsuccessful payments), and/or a ratio of payment credits (e.g., for returned merchandise) to overall payment transactions.

A user's NFC-based credit rating may be used in various ways such as by a seller of goods and/or services or by an escrow payment services provider to determine whether to accept an NFC-based payment from the user. To illustrate, the user may offer to pay for a product through an NFC transaction by bumping the user's mobile user device to an NFC-enabled checkout register device. The checkout device may use information received through the NFC transaction to request and receive, from a third-party service provider, an NFC transaction rating for the user. The checkout device may determine whether to accept an NFC payment from the user based on the rating, or the checkout device may present the rating to an operator for use by the operator in determining whether to accept an NFC payment form the user. The user's NFC-based credit rating may be used in this or a similar manner in a real world payment scenario and/or in a virtual reality payment scenario.

In certain embodiments, application facility 106 may provide an NFC transaction based service by authenticating a user and/or a device based at least in part on one or more tracked NFC transactions. The NFC-based authentication may be a standalone authentication or part of a layered and/or combinatorial authentication. Examples of NFC-based authentication will now be described.

In certain embodiments, application facility 106 may provide an NFC transaction based service by using one or more NFC transactions to authenticate a user to a service and/or service feature. For example, a user may bump the user's mobile user device to a CPE device 302 to authenticate the user to the CPE device 302 and thereby gain access to a service and/or service feature provided by the CPE device 302.

In certain embodiments, application facility 106 may provide an NFC transaction based service by using one or more NFC transactions together with one or more other modes of authentication to authenticate a user to a service and/or service feature (e.g., to gain access to a patient's medical records, a virtual medical visit with a patient or doctor, and/or any other service, service feature, and/or content). As an example, application facility 106 may use an NFC transaction together with a physical location based mode of authentication to authenticate a user to a service and/or service feature. To illustrate, a mobile user device may be bumped to a CPE device 302 at a customer premises to initiate an NFC transaction. The NFC transaction may be used as one layer of authentication. In addition, the physical location of the devices may be used as another layer of authentication. For example, the devices may be configured to determine the geographic locations of the devices (e.g., the GPS coordinates of the devices) and to report the graphical locations of the devices to a server device external of the customer premises. Application facility 106 may be configured to determine, from data stored by the server device, the exact physical locations of the devices at the time of the NFC transaction and verify that the devices are located at the same physical location (e.g., the same GPS coordinates and/or the same customer premises). From the combination of the NFC transaction and the physical locations of the devices, application facility 106 may provide authentication. In this or a similar manner, application facility 106 may provide a multi-layered authentication service that is based at least in part on one or more NFC transactions.

As another example, application facility 106 may use an NFC transaction together with a physical location based mode of authentication and/or a virtual communication mode of authentication to authenticate a user to a service and/or service feature. For example, a user of a CPE device 302 at a customer premises may use the CPE device 302 to participate in a virtual audio/video communication with another user located at another location. For example, the user may participate in a virtual medical visit with medical service personnel by way of the virtual communication. Accordingly, a combination of the virtual communication (e.g., the medical service personnel verifying that the user is currently participating in the virtual communication), a physical location based authentication, and an NFC transaction based authentication may be used to provide a multilayer authentication. In some cases, such a multilayer authentication may be considered sufficient to satisfy government regulations (e.g., regulations governing virtual medical services and/or patient privacy).

In certain embodiments, application facility 106 may provide an NFC transaction based service by authenticating a user based at least in part on an NFC transaction that involves a biometric feedback device implanted in and/or worn by the user. To illustrate, a biometric feedback device implanted in and/or worn by the user may monitor biometric attributes of the user, such as the user's heart rate, blood sugar level, and/or any other biometric attributes. The biometric feedback device may be NFC-enabled or communicatively coupled to an NFC-enabled device implanted in and/or worn by the user. Accordingly, the biometric feedback device may provide biometric feedback data representative of the biometric attributes of the user to an NFC-enabled device that is within short range of the user (e.g., the user's mobile user device). For example, a user's smartphone device being held by the user may initiate an NFC transaction with the biometric feedback device and, through the NFC transaction, request and obtain biometric feedback data representative of the biometric attributes of the user. The user's smartphone device may use this data to authenticate the user to a service and/or service feature.

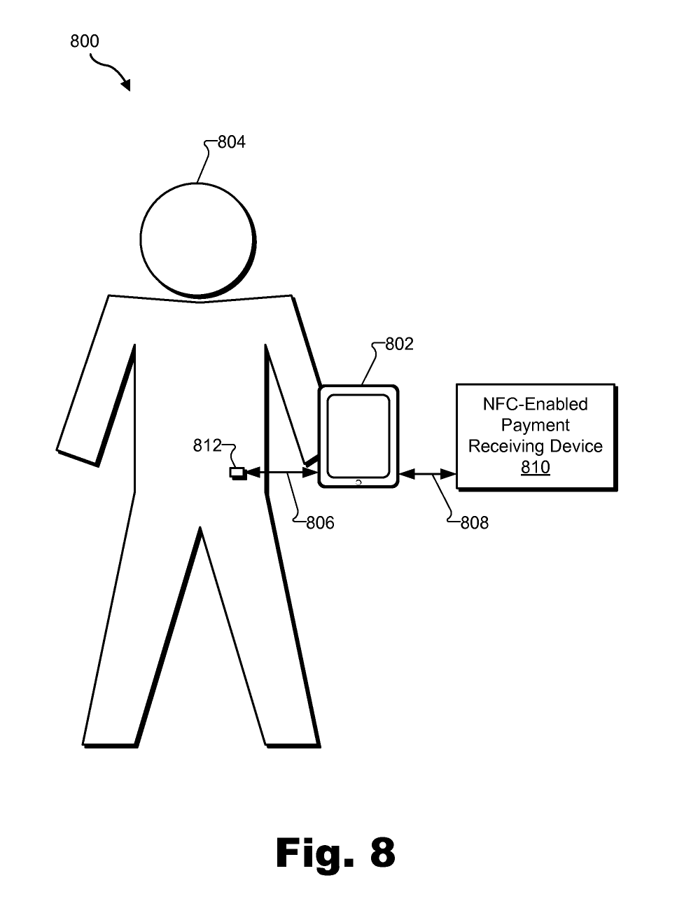

As an example, the user may want to use the user's smartphone device to render payment to another NFC-enabled device. To authenticate the user's identify and physical condition (e.g., that the user is alive and does not have a high heart rate that may indicate that the user is under duress), the user's smartphone device may request and receive biometric feedback data from the biometric feedback device implanted in and/or worn by the user by way of an NFC transaction. The user's smartphone device may then transmit, by way of an NFC transaction between the smartphone device and the other NFC-enabled device, the biometric feedback data to the other NFC-enabled device to authenticate the user's health and condition to the other NFC-enabled device. The other NFC-enabled device may use the data to authenticate the user and to determine whether to provide a service to the user (e.g., whether to accept payment from the smartphone device by way of the NFC transaction). FIG. 8 illustrates an exemplary implementation 800 of system 100 in which a smartphone device 802 operated by a user 804 participates in respective NFC transactions 806 and 808 with an NFC-enabled payment receiving device 810 and a biometric feedback device 812 implanted in user 804.

In certain embodiments, after application facility 106 has authenticated a user and/or device in any of the ways described herein, application facility 106 may provide an NFC transaction based service by providing a certificate of authentication. For example, application facility 106 may insert data representative of a certificate of authentication of the user and/or device into a communication, which may include a virtual audio/video communication and/or an NFC transaction (e.g., an NFC payment rendering transaction). The certificate may be usable by one or more entities as proof of authentication of the user and/or device. The certificate may be provided as a service to the entities.

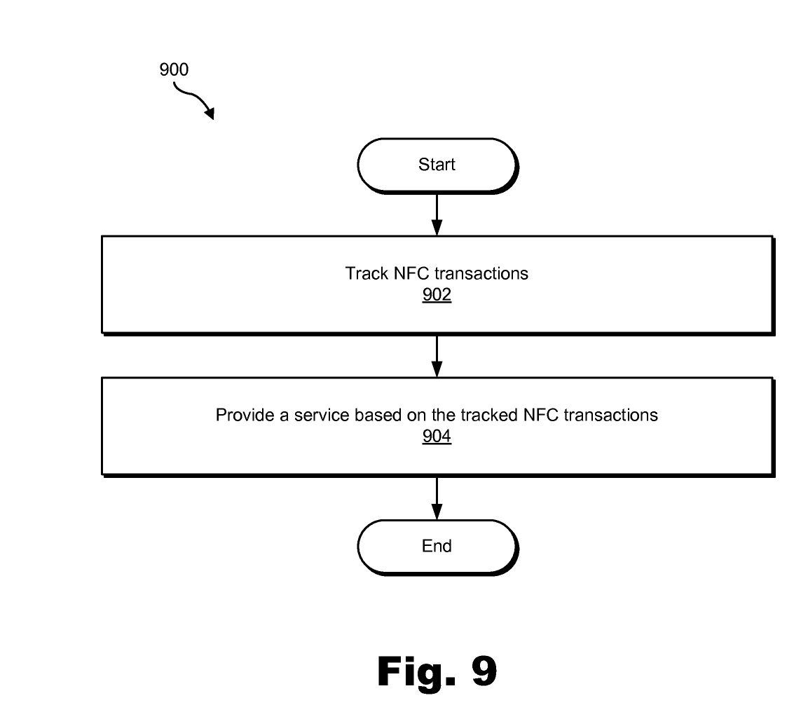

FIG. 9 illustrates an exemplary NFC transaction management and application method 900. While FIG. 9 illustrates exemplary steps according to one embodiment, other embodiments may omit, add to, reorder, combine, and/or modify any of the steps shown in FIG. 9. One or more of the steps shown in FIG. 9 may be performed by system 100 and/or any implementation thereof.

In step 902, a computing system tracks NFC transactions. Step 902 may be performed in any of the ways described herein, including by computing system 100 tracking NFC transactions by aggregating, over time, data representative of the NFC transactions associated with a profile (e.g., customer premises profile 200).

In step 904, the computing system provides a service based on the tracked NFC transactions. Step 904 may be performed in any of the ways described herein and may include providing any of the exemplary NFC-based services described herein.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random access memory (“DRAM”), which typically constitutes a main memory. Common forms of computer-readable media include, for example, a disk, hard disk, magnetic tape, any other magnetic medium, a CD-ROM, DVD, any other optical medium, a RAM, a PROM, an EPROM, a FLASH-EEPROM, any other memory chip or cartridge, or any other tangible medium from which a computer can read.

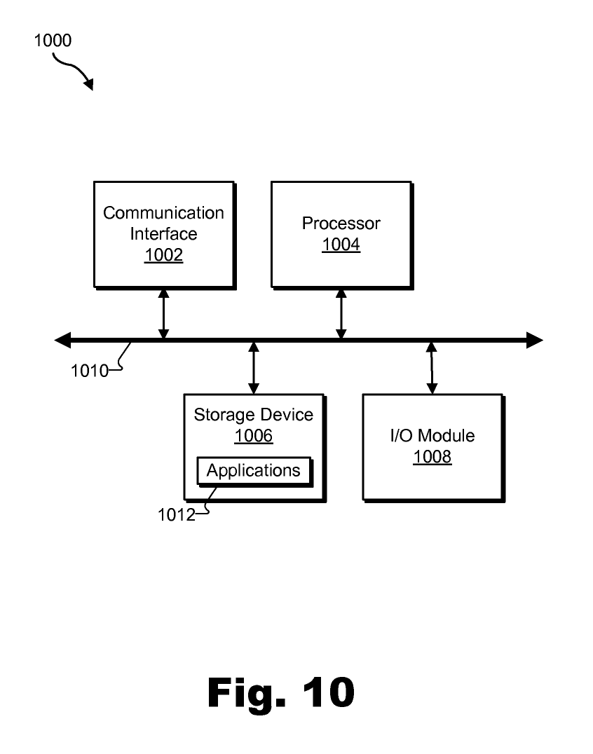

FIG. 10 illustrates an exemplary computing device 1000 that may be configured to perform one or more of the processes described herein. As shown in FIG. 10, computing device 1000 may include a communication interface 1002, a processor 1004, a storage device 1006, and an input/output (“I/O”) module 1008 communicatively connected via a communication infrastructure 1010. While an exemplary computing device 1000 is shown in FIG. 10, the components illustrated in FIG. 10 are not intended to be limiting. Additional or alternative components may be used in other embodiments. Components of computing device 1000 shown in FIG. 10 will now be described in additional detail.

Communication interface 1002 may be configured to communicate with one or more computing devices. Examples of communication interface 1002 include, without limitation, a wired network interface (such as a network interface card), a wireless network interface (such as a wireless network interface card), a modem, an audio/video connection, and any other suitable interface.

Processor 1004 generally represents any type or form of processing unit capable of processing data or interpreting, executing, and/or directing execution of one or more of the instructions, processes, and/or operations described herein. Processor 1004 may direct execution of operations in accordance with one or more applications 1012 or other computer-executable instructions such as may be stored in storage device 1006 or another computer-readable medium.

Storage device 1006 may include one or more data storage media, devices, or configurations and may employ any type, form, and combination of data storage media and/or device. For example, storage device 1006 may include, but is not limited to, a hard drive, network drive, flash drive, magnetic disc, optical disc, random access memory (“RAM”), dynamic RAM (“DRAM”), other non-volatile and/or volatile data storage units, or a combination or sub-combination thereof. Electronic data, including data described herein, may be temporarily and/or permanently stored in storage device 1006. For example, data representative of one or more executable applications 1012 configured to direct processor 1004 to perform any of the operations described herein may be stored within storage device 1006. In some examples, data may be arranged in one or more databases residing within storage device 1006.

I/O module 1008 may be configured to receive user input and provide user output and may include any hardware, firmware, software, or combination thereof supportive of input and output capabilities. For example, I/O module 1008 may include hardware and/or software for capturing user input, including, but not limited to, a keyboard or keypad, a touch screen component (e.g., touch screen display), a receiver (e.g., an RF or infrared receiver), and/or one or more input buttons.

I/O module 1008 may include one or more devices for presenting output to a user, including, but not limited to, a graphics engine, a display (e.g., a display screen, one or more output drivers (e.g., display drivers), one or more audio speakers, and one or more audio drivers. In certain embodiments, I/O module 1008 is configured to provide graphical data to a display for presentation to a user. The graphical data may be representative of one or more graphical user interfaces and/or any other graphical content as may serve a particular implementation.

In some examples, any of the facilities described herein may be implemented by or within one or more components of computing device 1000. For example, one or more applications 1012 residing within storage device 1006 may be configured to direct processor 1004 to perform one or more processes or functions associated with transaction facility 102, management facility 104, and/or application facility 106. Likewise, storage facility 108 may be implemented by or within storage device 1006.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
tracking, by a computing system, near field communication (“NFC”) transactions associated with a customer premises profile specifying one or more customer premises equipment (“CPE”) devices for which to aggregate the NFC transactions; and
providing, by the computing system, a service based on the tracked NFC transactions associated with the profile.

2. The method of claim 1, wherein the tracking of the NFC transactions associated with the customer premises profile comprises aggregating the NFC transactions associated with the customer premises profile over time.

3. The method of claim 1, wherein the tracking comprises requesting and receiving an NFC transaction history from each of the one or more CPE devices specified by the customer premises profile.

4. The method of claim 1, wherein the service comprises:
enabling access to a feature provided by a CPE device included in the CPE devices and located at a customer premises when the tracked NFC transactions indicate that a mobile user device is physically located at the customer premises; and
disabling access to the feature provided by the CPE device included in the CPE devices and located at the customer premises when the tracked NFC transactions indicate that the mobile user device is not physically located at the customer premises.

5. The method of claim 1, wherein the service comprises modifying display content provided by a CPE device included in the CPE devices and located at a customer premises based on a physical location of a mobile user device indicated by the tracked NFC transactions.

6. The method of claim 1, wherein the service comprises modifying one or more operational settings of a CPE device included in the CPE devices and located at a customer premises in response to an NFC transaction included in the tracked NFC transactions, the NFC transaction being between the CPE device and a mobile user device associated with a user.

7. The method of claim 1, wherein the service comprises providing information about a physical feature of a customer premises.

8. The method of claim 7, wherein the information about the physical feature of the customer premises comprises at least one of information about an installation of the feature, maintenance performed on the feature, and a contractor who worked on the feature.

9. The method of claim 1, wherein the service comprises providing historical information about a CPE device included in the CPE devices and located at a customer premises.

10. The method of claim 9, wherein the historical information comprises an NFC transaction history including information about at least one of a purchase, a delivery, an installation, and maintenance of the CPE device.

11. The method of claim 1, wherein the service comprises providing a maintenance notification based on the tracked NFC transactions, the maintenance notification configured to notify a user of a recommended maintenance activity for a CPE device included in the CPE devices and located at a customer premises.

12. The method of claim 1, wherein the service comprises providing a user credit rating based on the tracked NFC transactions.

13. The method of claim 1, wherein the service comprises authenticating a user based on one or more of the tracked NFC transactions.

14. The method of claim 13, wherein the authenticating comprises using one or more of the tracked NFC transactions together with at least one other mode of authentication to provide a multi-layered authentication of the user.

15. The method of claim 1, wherein:
the tracked NFC transactions comprise an NFC transaction between a mobile user device associated with a user and a biometric feedback device implanted in the user; and
the service comprises authenticating the user based at least in part on the NFC transaction between the mobile user device associated with the user and the biometric feedback device implanted in the user.

16. The method of claim 1, wherein the service comprises inserting data representative of a certificate of authentication of the user into a communication.

17. The method of claim 1, embodied as computer-executable instructions on at least one non-transitory computer-readable medium.

18. A method comprising:
aggregating, by a computing system over time, data representative of near field communication (“NFC”) transactions associated with a customer premises profile specifying one or more customer premises equipment (“CPE”) devices for which to aggregate the NFC transactions; and
providing, by the computing system, a service based on the aggregate NFC transactions associated with the customer premises profile.

19. The method of claim 18, embodied as computer-executable instructions on at least one non-transitory computer-readable medium.

20. A system comprising:
a plurality of customer premises equipment (“CPE”) devices located at a customer premises, each CPE device included in the plurality of CPE devices configured to track near field communication (“NFC”) transactions in which the CPE device participates, the tracked NFC transactions forming an NFC transaction history for the CPE device; and
a mobile user device configured to initiate an NFC transaction with each CPE device included in the plurality of CPE devices and to request and receive, by way of the NFC transaction with each CPE device, the NFC transaction history for each CPE device.

21. The system of claim 20, further comprising:
a tracking device configured to communicate with one or more CPE devices included in the plurality of CPE devices by way of a network to request and receive, by way of the network, the NFC transaction history for each of the one or more CPE devices.

22. The system of claim 20, further comprising:
a tracking device configured to communicate with the mobile user device by way of a network to request and receive, by way of the network, the NFC transaction history for each CPE device.
